(19) United States
(12) Patent Application Publication
(10) Pub. No.: US 2010/0246069 A1
(43) Pub. Date: Sep. 30, 2010

(54) HARD DISK DRIVE

(75) Inventors: Jung Moo SON, Gunpo-si (KR); Hong Kwon Lee, Seongnam-si (KR); Byung-Soo Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/749,727

(22) Filed: Mar. 30, 2010

(30) Foreign Application Priority Data
Mar. 30, 2009 (KR) 2009-0027050

(51) Int. Cl. G11B 5/54; G11B 5/55

(52) U.S. Cl. 360/256.2; 360/264.7; G9B/5.181

(57) ABSTRACT

An HDD includes a head stack assembly, a voice coil motor, and a retracting pin unit. The retracting pin unit includes a mobile retracting pin generating a retracting force to maintain the actuator arm at a predetermined position by interacting with the magnet when the read/write head is parked, and coupled to the bobbin to be capable of relatively moving with respect to the bobbin toward the magnet when the bobbin is separated from the magnet due to an external shock. A head on disk phenomenon, in which the parking state of the read/write head is removed when an external shock such as a linear shock or a rotary shock, which may be generated as the HDD is installed in a notebook computer, is applied to the HDD, may be reduced.

### CROSS-REFERENCE TO RELATED APPLICATIONS

This application claims priority under 35 U.S.C. §119 to Korean Patent Application No. 10-2009-0027050, filed on Mar. 30, 2009, in the Korean Intellectual Property Office, the disclosure of which is incorporated by reference herein in its entirety.

### BACKGROUND

1. Field of the Invention

The inventive concept relates to an auxiliary memory device of a computer system, and more particularly, to a hard disk drive (HDD) capable of preventing a head on disk phenomenon in which a parking state of a read/write head is removed when an external shock is applied to an HDD.

2. Description of the Related Art

HDDs are data storage devices capable of recording data on a disk or reproducing data stored on the disk using a read/write head. The HDD is widely used as an auxiliary memory device for computer systems because of its fast access time to a large amount of data.

With the recent increase in TPI (tracks per inch) and BPI (bits per inch), the HDD is implemented to have a high capacity and extended application fields. Accordingly, compact HDDs which may be used for portable electronic products such as laptops, personal digital assistants (PDAs), and mobile phones have been actively developed. For example, an HDD having a diameter of 2.5 inches has already been developed and applied to laptops. Also, a compact HDD having a relatively smaller diameter, for example, 0.8 inches, or equivalent to that of a coin, has been actively developed and is already employed, or is expected to be employed, in mobile phones or MP3 players.

In general, the HDD includes a disk pack, a printed circuit board assembly (PCBA), a base, a cover, a head stack assembly (HSA) including an actuator arm having a read/write head mounted thereon and a bobbin, a voice coil motor (VCM), a ramp, a latch device, and a retracting pin coupled to the bobbin to magnetically interact with a magnet.

The retracting pin generates a retracting force to retract the read/write head back to the ramp by interacting with the magnet when current is not applied to the voice coil motor coil, or in other words when the HDD is not operating to lock the actuator arm in the latch device. When the read/write head is parked on the ramp, the retracting pin is attracted to the voice coil magnet to maintain the actuator arm at a particular position.

However, in a conventional HDD, the retracting pin is fixedly coupled to the bobbin, so that when the HDD receives an external shock, the bobbin instantly moves as a result of the shock and thus the position of the retracting pin is forced out of an attraction range of the magnet. Thus, the retracting force of the retracting pin to maintain the actuator arm at the particular position is not generated and the read/write head is forced out of its parked state. Accordingly, the read/write head moves over the disk and may contact the disk, which may damage the read/write head, the disk, or both.

### SUMMARY

The inventive concept provides an HDD which may reduce head-to-disk contact in which the read/write head of a head stack assembly is forced out of its parked stated due to an external shock.

Additional features and utilities of the present general inventive concept will be set forth in part in the description which follows and, in part, will be obvious from the description, or may be learned by practice of the general inventive concept.

Features and/or utilities of the present general inventive concept may be realized by a hard disk drive including a head stack assembly including an actuator arm having a read/write head mounted thereon to pivot across a disk around a pivot shaft installed on a base, a pivot shaft holder rotatably supporting the pivot shaft and to which the actuator arm is coupled, and a bobbin located at the opposite side of the actuator arm with respect to the pivot shaft holder and having at least one surface on which a voice coil installed, a voice coil motor including a magnet generating an electromagnetic force to pivot the actuator arm by interacting with the voice coil when current flows in the voice coil, and a retracting pin unit including a mobile retracting pin generating a retracting force to maintain the actuator arm at a predetermined position by interacting with the magnet when the read/write head is parked, and coupled to the bobbin to be capable of relatively moving with respect to the bobbin toward the magnet when the bobbin is separated from the magnet due to an external shock.

The retracting pin unit may include a pin guide rail located at the rear end portion of the bobbin and coupled to the bobbin to be capable of relatively moving the mobile retracting pin with respect to the bobbin, and a retraction spring having one end portion contacting the bobbin and the other end portion contacting the mobile retracting pin and elastically biasing the mobile retracting pin to an initially set position.

The retraction spring may be an elastic spring that elastically biases the mobile retracting pin toward the initially set position.

The elastic spring may be arranged close to the magnet in the pin guide rail, and the mobile retracting pin may be arranged at the side of the elastic spring in a direction to be separated from the magnet.

The pin guide rail may be provided in the bobbin along a rotation direction of the bobbin that rotates around the pivot shaft as a rotation center.

An escape prevention unit to prevent the mobile retracting pin from escaping from the pin guide rail may be provided in an area close to the pin guide rail of the bobbin.

The mobile retracting pin may be formed of a magnetic material having the same magnetic polarity as that of the magnet so as to generate an attraction force when the magnet and the mobile retracting pin magnetically interact with each other.

The hard disk drive may further include a ramp coupled to the base and on which the read/write head is parked, and a latch device coupled to the base and locking the actuator arm at a predetermined position when the rotation of the disk is stopped.

The latch device may include a hook portion protruding from the bobbin, and a latch lever coupled to the base to be capable of pivoting and having a catch portion to catch or release the hook portion, and the retracting pin unit may be coupled to an area of the hook portion.

The latch lever may further include a latch arm in which the catch portion is provided at a leading end portion thereof. The catch portion may include a first hook provided at the latch arm and to which the hook portion is hook-coupled, and a second hook provided at the latch arm close to the first hook and to which the hook portion that is not hook-coupled to the first hook is hook-coupled.

Features and/or utilities of the present general inventive concept may also be realized by a head stack assembly including an actuator arm to pivot around a shaft and a bobbin on a side of the shaft opposite the actuator arm. The bobbin may include a retracting pin unit including a pin that moves with respect to the bobbin to maintain a magnetic interaction with a magnet.

The pin may be made of a magnetic material.

The retracting pin unit may include first rail guides to restrict movement of the pin in a first direction and a retraction spring connected to the pin to generate a force in a direction opposite a rotation direction of the bobbin.

The retracting pin unit may include a recess in a surface of the bobbin, the rail guides may include side walls of the bobbin, and the pin and retraction spring may be located within the recess.

The head stack assembly may include second rail guides to restrict movement of the pin in a second direction perpendicular to the first direction, and, when a rotation direction of the bobbin is a substantially horizontal third direction, the first direction may be a horizontal direction perpendicular to the third direction, and the second direction may be a vertical direction perpendicular to each of the first and third directions.

The second rail guides may include a cover mounted to the bobbin to cover a portion of the retracting pin unit.

The first rail guides may be mounted on an outer surface of the bobbin.

The retraction spring may be a coil.

The retraction spring may be a compressible porous material.

The retraction spring may be a thin metal strip mounted to an inside wall of the retracting pin unit.

The retraction spring may have a de-compressed rest state, such that when a first force applied to the retraction spring by the pin to move the retraction spring into a compressed state, the retraction spring applies a second force to the pin in a direction opposite the first force to move the retraction spring back into a de-compressed state.

The retraction spring may have a compressed rest state, such that when a first force is applied to the retraction spring by the pin to move the retraction spring into a de-compressed state, the retraction spring applies a second force to the pin in a direction opposite the first force to move the retraction spring back into a compressed state.

The retraction spring may be directly connected to an inside wall of the retracting pin unit and to the pin.

The retraction spring may be directly connected only to an inside wall of the retracting pin unit.

The bobbin may include a hook portion to hook a latch device, and the retracting pin unit may be located on the hook portion of the bobbin.

Features and/or utilities of the present general inventive concept may also be realized by a hard disk drive (HDD) including a hard disk and a head stack assembly. The head stack assembly may include a read/write head to read data from and write data to the hard disk, an actuator arm to pivot around a shaft, and a bobbin on a side of the shaft opposite the actuator arm, the bobbin including a retracting pin unit including a pin that moves with respect to the bobbin to maintain a magnetic interaction with a magnet.

The hard disk drive may include a base on which the head stack assembly and the hard disk are rotatably mounted, a ramp to receive an end of the actuator arm corresponding to the read/write head when the hard disk drive is not in operation, and a latch device to hold the actuator arm in a parked state on the ramp when the hard disk drive is not in operation.

The hard disk drive may include a voice coil motor including the magnet that is fixed with respect to the shaft of the actuator arm to move the actuator arm over the hard disk when the hard disk drive is in operation, and the retracting pin may maintain magnetic interaction with the magnet of the voice coil motor when the hard disk drive is not in operation.

Features and/or utilities of the present general inventive concept may also be realized by a computing device including a hard disk drive (HDD) including a hard disk, a head stack assembly, and a controller. The head stack assembly may include a read/write head to read data from and write data to the hard disk, an actuator arm to pivot around a shaft, and a bobbin on a side of the shaft opposite the actuator arm, the bobbin including a retracting pin unit including a pin that moves with respect to the bobbin to maintain a magnetic interaction with a magnet. The controller may control read operations from and write operations to the hard disk.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a partially exploded perspective view of an HDD according an exemplary embodiment of the present general inventive concept;

FIG. 2 is a plan view of the HDD of FIG. 1 without the cover;

FIG. 3 is an enlarged view of the bobbin of the HDD of FIG. 1;

FIG. 4 is an enlarged view illustrating major portions of FIG. 3;

FIG. 5 illustrates the external shock applied to the HDD of FIG. 1 when the HDD is installed in a notebook computer;

FIG. 6 is a graph showing an example of a linear shock or a rotary shock generated during the installation of the HDD as illustrated in FIG. 5;

FIG. 7 schematically illustrates the state of the retracting pin unit before an external shock is applied;

FIG. 8 schematically illustrates the state of the retracting pin unit after the external shock applied;

FIG. 9 schematically illustrates a retracting pin unit of an HDD according to another exemplary embodiment of the present inventive concept;

FIGS. 10A-10C illustrate examples of retracting pins according to the present general inventive concept;

FIGS. 11A-11C illustrate examples of retracting pin spring units according to the present general inventive concept;

FIGS. 12A-12D illustrate examples of retracting pin units according to the present general inventive concept;

FIGS. 13A-13D illustrate examples of operation of retracting pin spring units according to embodiments of the present general inventive concept; and

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

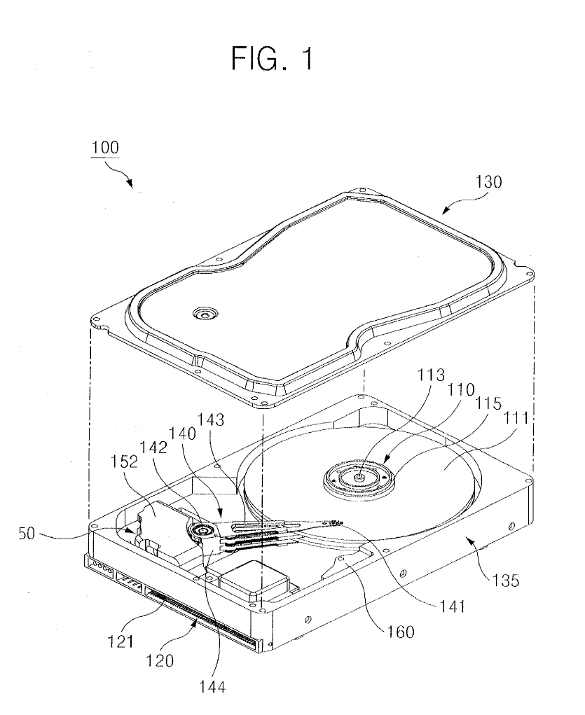

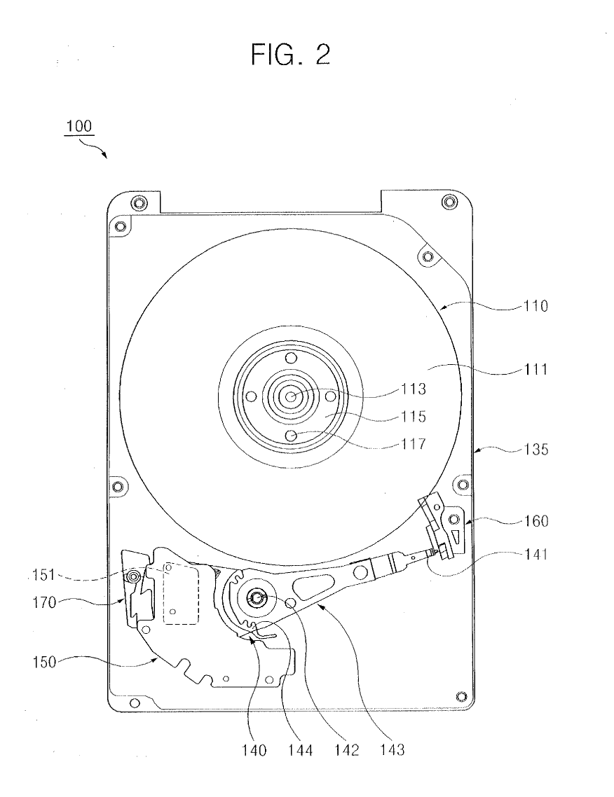

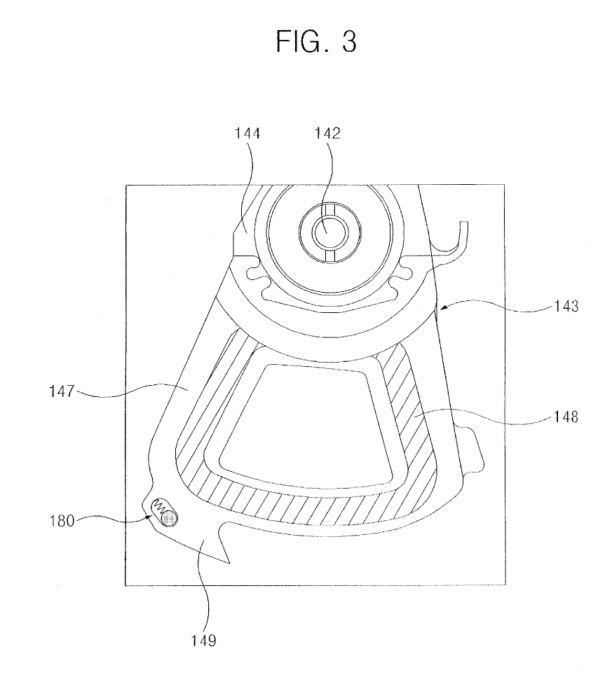

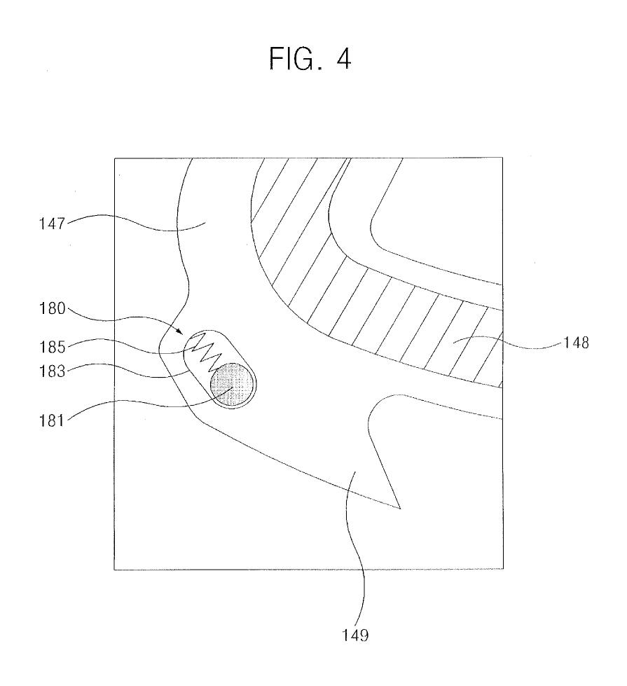

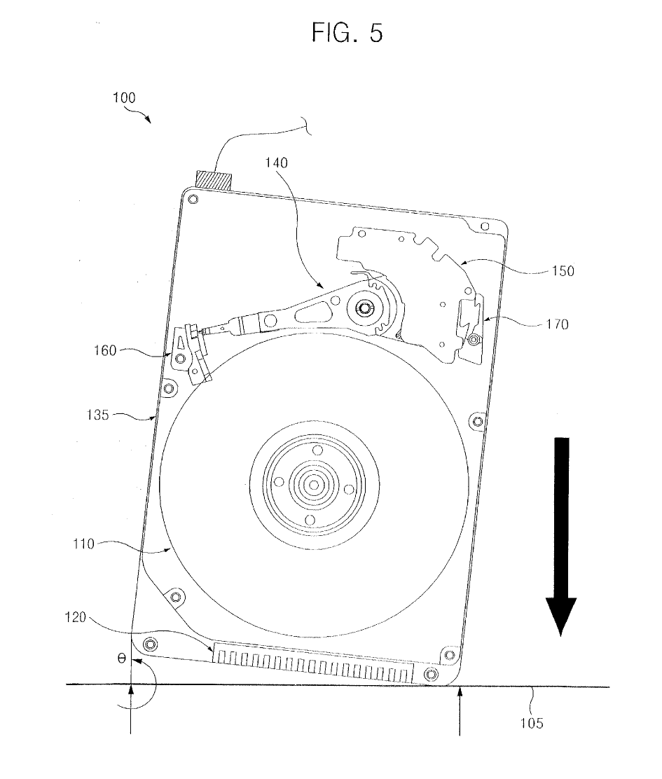

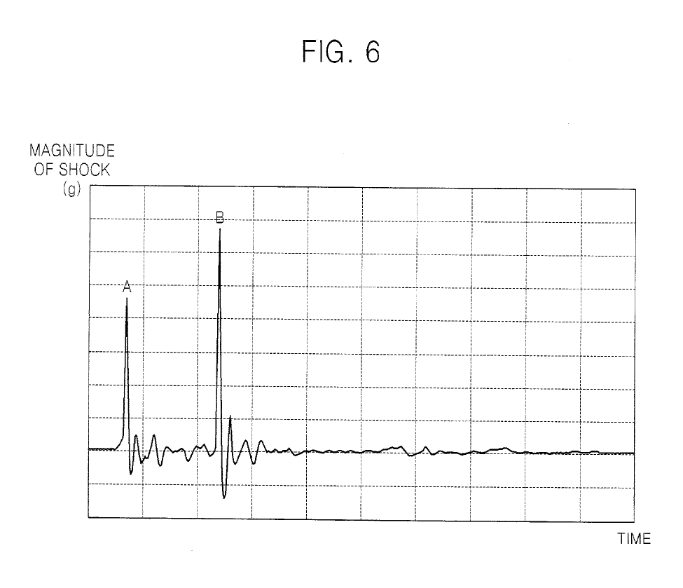

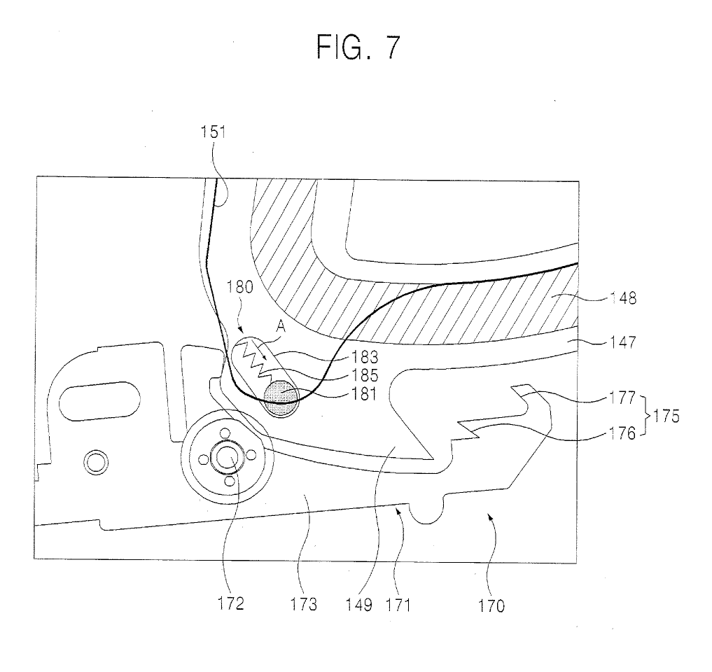

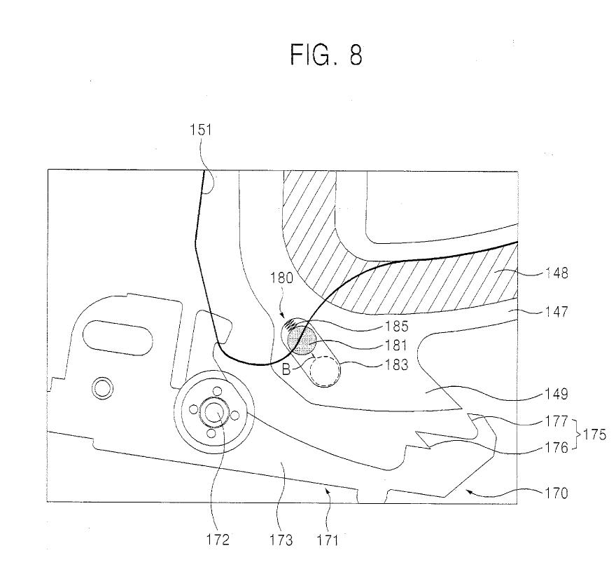

FIG. 1 is a partially exploded perspective view of an HDD according an exemplary embodiment of the present general inventive concept. FIG. 2 is a plan view of the HDD of FIG. 1 without the cover. FIG. 3 is an enlarged view of the bobbin of the HDD of FIG. 1. FIG. 4 is an enlarged view illustrating major portions of FIG. 3. FIG. 5 illustrates the external shock applied to the HDD of FIG. 1 when the HDD is installed in a notebook computer. FIG. 6 is a graph showing an example of a linear shock or a rotary shock generated during the installation of the HDD as illustrated in FIG. 5. FIG. 7 schematically illustrates the state of the retracting pin unit before an external shock is applied. FIG. 8 schematically illustrates the state of the retracting pin unit after the external shock is applied.

Referring to FIGS. 1-8, a hard disk drive (HDD) 100 according to an exemplary embodiment of the present general inventive concept includes a disk pack 110 having a disk 111, a printed circuit board assembly (PCBA) 120, a base 135, a cover 130, a head stack assembly (HSA) 140, a ramp 160 attached to the base 135, and a latch device 170. The head stack assembly 140 has an actuator arm 143 including a read/write head 141 and a bobbin 147. A voice coil motor (VCM) coil 148 is mounted on the bobbin 147, and the VCM coil 148 is a part of a voice coil motor (VCM) 150 that pivots the actuator arm 143. The VCM 150 also includes a magnet 151 that is mounted to the base 135 and interacts with the VCM coil 148 to move the actuator arm 143. The ramp 160 is mounted to the base 135 and the read/write head 141 is parked on the ramp 160 when the HDD is not operational. The latch device 170 includes a latch arm 173 mounted to the base 135, a hook portion 149 on the bobbin 147, and a catch portion 175 on the latch arm 173 to catch the hook portion 149 to prevent the read/write head 141 from moving toward the disk 111 when the HDD is not operational. The bobbin 147 includes a retracting pin unit 180 to generate a retraction force to retract the read/write head 141 back toward the ramp 160 when the read/write head 141 is moved from the ramp 160 by a shock when the HDD is not in operation.

The disk pack 110 includes the disk 111, a shaft 113 to rotate the disk 111, a spindle motor hub (not shown) provided radially at the outside of radial direction of the shaft 113 and supporting the disk 111, a clamp 115 coupled to the upper portion of the spindle motor hub, and a clamp screw 117 to press the clamp 115 to fix the disk 111 to the spindle motor hub.

The PCBA 120 includes a plate shaped printed circuit board (PCB; not shown) and a PCB connector 121 located at an end of the PCB. The PCB includes a plurality of chips and circuits (not shown) to control the disk 111 and the read/write head 141 and may communicate with an external apparatus via the PCB connector 121.

The base 135 forms a frame, and the disk pack 110, the HSA 140, and the PCBA 120 are assembled on the base 135. Also, the ramp 160 is installed on the base 135. The cover 130 protects the disk 111 and the HSA 140 by shielding the upper surface of the base 135.

The head stack assembly 140 records data onto the disk 111 or reproduces data from the disk 111. The HSA 140 includes the actuator arm 143 to pivot around a pivot shaft 142 so that the read/write head 141 may access data on the disk 111. The HSA also includes a suspension (not shown) coupled to the end portion of the actuator arm 143, a pivot shaft holder 144 to rotatably support the pivot shaft 142 and to support the actuator arm 143 that is coupled thereto, and the bobbin 147 located at the opposite end of the actuator arm 143 from the read/write head 141 with respect to the pivot shaft holder 144. The bobbin 147 is arranged adjacent to the magnet 151 of the VCM 150 to allow the VCM coil 148 to interact with the VCM magnet 151 to drive the actuator arm 143.

The read/write head 141 reads or writes information from or to the rotating disk 111 by sensing a magnetic field formed on the surface of the disk 111 or by magnetizing the surface of the disk 111, respectively. The read/write head 141 includes a read head (not shown) to sense the magnetic field of the disk 111 and a write head (not shown) to magnetize the disk 111.

The VCM 150 is a type of a driving motor that pivots the actuator arm 143 of the HSA 140 to move the read/write head 141 to a desired position on the disk 111 by utilizing the Fleming's left hand rule. According to Fleming's left hand rule, when current is applied to a conductive body existing in a magnetic field, an electromagnetic force is generated. As current applied to the VCM coil 148 located adjacent to the magnet 151, a force is generated and applied to the bobbin 147 to move the bobbin 147 around the pivot shaft 142 to pivot the actuator arm 143. Accordingly, as the actuator arm 143 pivots in a predetermined direction, the read/write head 141 mounted at the end portion of the actuator arm 143 may move in a radial direction of the disk 111 that is rotating, and may simultaneously search and access a desired track (not shown). Thus, the data may be recorded on the disk 111 or the recorded data may be reproduced from the disk 111.

According to the above-described structure, when power is applied to the HDD 100, the disk 111 starts to rotate. When the read/write head 141 coupled to the leading end portion of the actuator arm 143 is positioned over the rotating disk 111, the read/write head 141 is raised to a predetermined height by a lift force generated during the rotation of the disk 111 and writes data to the disk 111 or reads data from the disk 111.

In contrast, when the supply of power to the HDD 100 is discontinued, the rotation of the disk 111 stops and the actuator arm 143 is rotated around the pivot shaft 142 and parked on the ramp 160. When the HDD 100 receives an external shock, an end tab (not shown) formed at the leading end portion of the actuator arm 143 may be dislodged from the ramp 160, and the actuator arm 143 may pivot toward the disk 111. The read/write head 141 may be moved to a data area of the disk 111, and since the disk 111 is not rotating, the read/write head 141 is not raised to a predetermined height above the disk 111. Thus, the read/write head 141 may contact the disk 111 so that either the read/write head 141 or the disk 111 may be damaged.

To prevent the head-to-disk contact, the HDD 100 further includes the latch device 170 to latch the bobbin 147 located at end portion of the actuator arm 143 opposite the read/write head 141 when the power is not applied.

The latch device 170 automatically unlatches the actuator arm 143 when current is applied to the voice coil 148 by using the electromagnetic force generated by the VCM 150 to move the read/write head 141 over the disk 111. When current is not applied to the voice coil 148, the latch device 170 firmly latches the actuator arm 143.

The latch device 170 according to the present exemplary embodiment includes, as illustrated in FIGS. 7 and 8, a latch lever 171 rotatably installed on the base 135 and a hook portion 149 provided on the bobbin 147 of the actuator arm 143 to be hook-coupled to, or released from, the latch lever 171.

The latch lever 171 includes a pivot center portion 172, a latch arm 173 coupled to the pivot center portion 172 to pivot around the pivot center portion 172, and a catch portion 175 provided at the leading end portion of the latch arm 173 to catch the hook portion 149 of the bobbin 147 when the actuator arm 143 rotates counterclockwise.

The latch arm 173 pivots around the center of the pivot center portion 172 so that the hook portion 149 of the bobbin 147 may be latched by or unlatched from the catch portion 175. In other words, when an external rotary shock in a clockwise or counterclockwise direction is applied to the HDD 100, an inertia force is generated in the latch arm 173 to move in the opposite direction to the direction of the external force. Due to the inertial force, the hook portion 149 of the bobbin 147 may be latched by the catch portion 175 protruding from the leading end portion of the latch arm 173. Accordingly, the actuator arm 143 may be prevented from freely pivoting.

As illustrated in FIGS. 7 and 8, the catch portion 175 includes a first hook 176 protruding from the latch arm 173 to catch the hook portion 149 during the counterclockwise rotation of the bobbin 147 and a second hook 177 protruding from the latch arm 173 close to the first hook 176 to catch the hook portion 149 when the first hook 176 fails to do so.

According to the catch portion 175 configured as above, even when the first hook 176 fails to catch the hook portion 149 to prevent the actuator arm from pivoting, the second hook portion 177 that is closer to the leading end portion of the latch arm 173 may catch the hook portion 149. For example, the first hook 176 may fail to catch the hook portion 149 if a shock moves the latch arm 173 out of its initial position and the first hook 176 fails to return to its initial position before the hook portion 149 passes the location of the first hook 176. In such a case, since the second hook 177 is farther along the latch arm 173 in a rotational direction, the second hook 177 may still catch the hook portion 149.

The retracting pin unit 180 interacts with the magnet 151 of the VCM 150 to generate a retracting force to retract the read/write head 141 back to the ramp 160 when the disk 111 stops rotation, so that the latch device 170 may latch the actuator arm 143. In addition, the retracting pin unit 180 helps to maintain the read/write head 141 on the ramp 160 when the HDD 100 is not operational.

As illustrated in FIGS. 3, 4, 7, and 8, the retracting pin unit 180 includes the mobile retracting pin 181 which is formed of a magnetic material to interact with the magnet 151, a pin guide rail 183 provided in the hook portion 149 of the bobbin 147 to guide the movement of the mobile retracting pin 181, and a pin restoration unit or spring 185 having one end portion coupled to the pin guide rail 183 and the other end portion coupled to the mobile retracting pin 181. The pin spring 185 biases the mobile retraction pin 181 towards its initial setting position or rest position. Although the pin restoration unit 185 may be referred to as a retracting spring or retraction spring in the specification and claims, the term “spring” refers to a physical quality of providing an elastic resistance force, rather than referring to a particular type of spring structure. In other words, as will be illustrated below, various structures may be used to provide the elastically resistive force of the retraction spring 185.

In the retracting pin unit 180 of the present exemplary embodiment, the mobile retracting pin 181 is coupled to the bobbin 147 to be capable of relatively moving with respect to the bobbin 147. Thus, when the HDD 100 receives an external shock and the bobbin 147 is moved with respect to the magnet 151, the retracting pin unit 180 may push the bobbin 147 back toward the magnet 151.

Referring to FIGS. 5 and 6, when the HDD 100 is installed in the notebook, a linear shock A and a rotary shock B may be sequentially applied to the HDD 100, as illustrated in FIG. 6. Since a conventional retracting pin may be fixedly coupled to the bobbin 147, when the bobbin 147 pivots due to the linear shock and the rotary shock, the position of the retracting pin may be moved past a threshold point where the retracting pin may magnetically interact with the magnet 151. Thus, the retracting pin does not generate a retraction force and the read/write head 141 may contact the disk 111 and damage either the head 141 or the disk 111.

Another method that may be used to attempt to prevent the head-to-disk contact phenomenon is to use a retraction pin (not shown) having a relatively long length on the hook portion 149 of the bobbin 147 so that when an external shock is applied to the HDD 100, even if the long retraction pin is moved, the long retraction pin may still be within the threshold point where it may interact with the magnet 151 to prevent the actuator arm 143 from leaving its parked state and to prevent the read/write head 141 from contacting the disk 111. However, when the above method is employed, the mutual attraction force between the magnet 151 and the retracting pin may be too strong, so that the actuator arm 143 may not be smoothly unlatched from the catch portion 175 of the latch arm 173.

However, the retracting pin unit 180 of the HDD 100 according to the present exemplary embodiment is capable of both interacting with the magnet 151 after being moved due to an external shock and allowing the actuator arm 143 to be smoothly unlatched from the latch arm 173. That is, when a linear shock and a rotary shock are applied to the HDD 100, to separate the bobbin 147 from the magnet 151, the mobile retracting pin 181 moves toward the magnet 151 with respect to the bobbin 147 while maintaining a retraction force due to the retraction spring 185. Accordingly, the magnetic interaction range between the mobile retracting pin 181 and the magnet 151 increases, thereby preventing contact between the head 141 and the disk 111.

The mobile retracting pin 181 may be formed of a magnetic material having the same magnetic polarity as that of the magnet 151 so as to generate the mutual attraction force therebetween. In FIGS. 7 and 8, the line labeled 151 represents an outer edge of the magnet 151. As illustrated in FIG. 7, when the read/write head 141 is parked on the ramp 160, the mobile retraction pin 181 may be located such that only a portion of the mobile retracting pin 181 located adjacent to the magnet 151. For example, approximately half of the mobile retracting pin 181 may be located adjacent to the magnet 151. According to this arrangement, an attraction force is generated between the mobile retracting pin 181 and the magnet 151 so that the actuator arm 143 may be maintained at a particular position.

The pin guide rail 183 is provided on the hook portion 149 of the bobbin 147 to extend along the rotational direction of the bobbin 147. The mobile retracting pin 181 is coupled to the pin guide rail 183 to be capable of relatively moving with respect to the bobbin 147. Thus, when the bobbin 147 pivots due to an external shock, the mobile retracting pin 181 moves along the pin guide rail 183 in the opposite direction to the direction in which the bobbin 147 pivots.

The retraction spring 185 elastically biases the mobile retracting pin 181 to the initial position. One end portion of the retraction spring 185 contacts, or is fixedly coupled to, an inner surface of one end portion of the pin guide rail 183. The other end portion of the retraction spring 185 contacts, or is fixedly coupled to, an outer surface of the mobile retracting pin 181. Although in the present exemplary embodiment the retraction spring 185 is an elastic spring having an elastic force, the present inventive concept is not limited thereto. Any member or device may be used to elastically bias the position of the mobile retracting pin 181 to the initial position.

In the operation of the retraction spring 185, the retraction spring 185 may be located in an area of the pin guide rail 183 close to the magnet 151 and may press the mobile retracting pin 181 arranged close to the retraction spring 185 in a direction indicated by an arrow A of FIG. 7, so that the mobile retracting pin 181 may be located at the initially set position of the pin guide rail 183. In this state, when a linear shock and/or a rotary shock are applied to the HDD 100, the bobbin 147 pivots and may be separated from the magnet 151. However, the mobile retracting pin 181 may be moved by an inertial force in an opposite direction B with respect to the pivot direction of the bobbin 147. In other words, the pin guide rail 183 and retraction spring 185 allow the retraction pin 181 to move with respect to the bobbin 147 to maintain magnetic interaction with the magnet 151 while also maintaining a retraction force on the bobbin 147. When the bobbin 147 is returned to its original position, the retraction spring 185 is restored to its rest state from a compressed state.

According to the above-described structure, when current is not applied, the latch state of the actuator arm 143 may be maintained by the magnetic force acting between the magnet 151 and the mobile retracting pin 181 and the latch device 170. When a linear shock and/or a rotary shock are applied to the HDD 100 to move the bobbin 147 away from the magnet 151, the mobile retracting pin 181 maintains the mutual magnetic force between the magnet 151 and the mobile retracting pin 181, and the latch state may also be maintained or restored.

Thus, since the magnetic interaction of the retracting pin 181 and the magnet 151 prevents the actuator arm 143 from moving out of its parked state, the head-to-disk contact phenomenon may be prevented.

On the other hand, when current is applied to the VCM coil 148, since the electromagnetic force generated by the mutual electromagnetic operation between the voice coil 148 of the bobbin 147 and the magnet 151 of the VCM 150 is greater than the magnetic force acting between the magnet 151 and the mobile retracting pin 181, the actuator arm 143 may be smoothly unlatched from the latch device 170 so that the read/write head 141 mounted on the leading end portion of the actuator arm 143 may be moved to a predetermined position over the disk 111.

According to the present exemplary embodiment, since the mobile retracting pin 181 is capable of moving with respect to the bobbin 147 along the pin guide rail 183, the area in which the mobile retracting pin 181 and the magnet 151 magnetically interact increases. Accordingly, even when a linear shock and a rotary shock are sequentially applied to the HDD 100, the head-to-disk contact phenomenon in which the parking state of the read/write head 141 is freely removed may be reduced.

An HDD according to another exemplary embodiment of the present inventive concept will be described below with reference to the accompanying drawings. For convenience of explanation, the descriptions on the same constituent elements in the above-described exemplary embodiment and the present exemplary embodiment will be omitted herein.

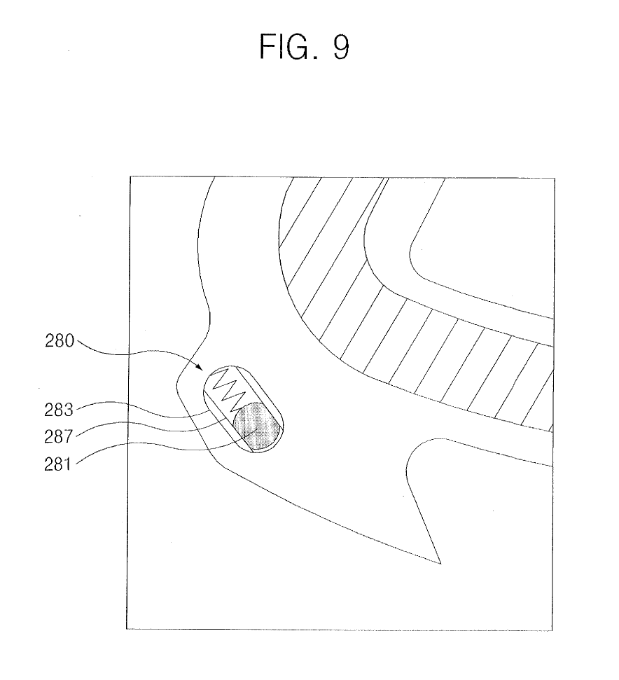

FIG. 9 schematically illustrates a retracting pin unit 280 of an HDD according to another exemplary embodiment of the present general inventive concept. Referring to FIG. 9, unlike the above-described exemplary embodiment of FIGS. 1-8, the retracting pin unit 280 of the present exemplary embodiment further includes an escape prevention unit 287 provided along the circumferential direction of each of the upper end portion and the lower end portion of a pin guide rail 283 in which a retraction spring 285 and a mobile retracting pin 281 are installed. The escape prevention unit 287 may slightly protrude inwardly from each of the upper and lower end portions of the pin guide rail 283. Accordingly, the escape prevention unit 287 may prevent the mobile retracting pin 281 from escaping in the up or down direction. In other words, while the guide rail 283 may restrict movement of the retraction spring 285 in a lateral or first horizontal direction, the escape prevention unit 287, or second guide rail, may restrict movement of the retracting pin 281 in a vertical direction perpendicular to the horizontal direction.

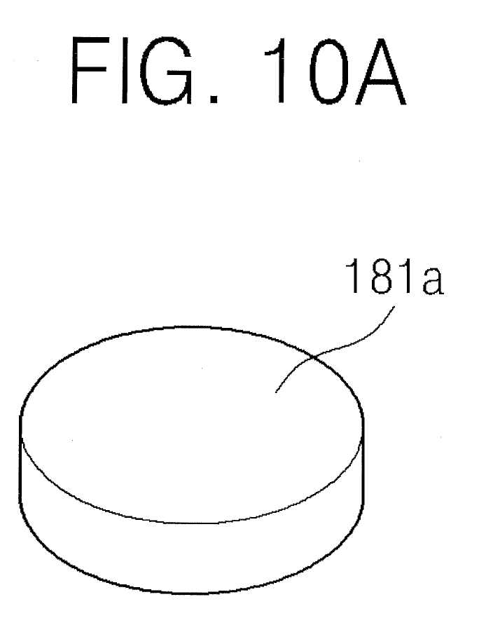

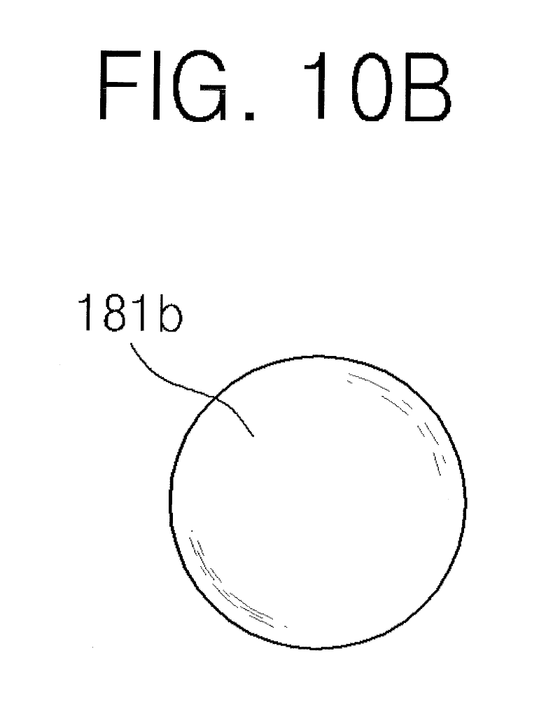

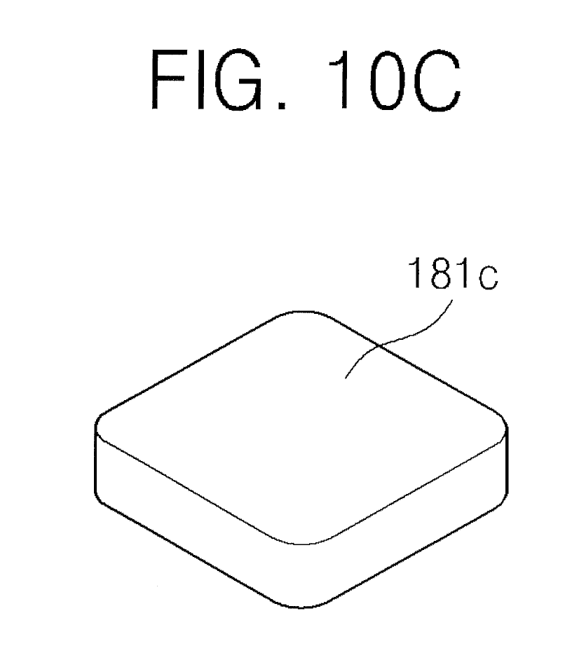

FIGS. 10A-10C illustrate retracting pins 181 according to example embodiments of the present general inventive concept. However, the retracting pin 181 may have any shape, depending on design preferences or requirements of the HDD 100. FIG. 10A illustrates a retracting pin 181a having a substantially cylindrical shape. In such a case, the retraction unit 180 may be designed to allow the retracting pin 181a to slide along it flat, circular surfaces or to slide along its rounded outer surface.

FIG. 10B illustrates a retracting pin 181b having a spherical shape, and FIG. 10C illustrates a retracting pin 181c having a square shape with rounded corners. Although a few examples are illustrated in FIGS. 10A-10C, a retracting pin 181 may have any shape, including a three-dimensional polygonal shape, such as rectangular, square, oval, or other shape, and the width, length, and thickness of the retracting pin 181 may be varied according to the desired configuration and properties of the HDD 100.

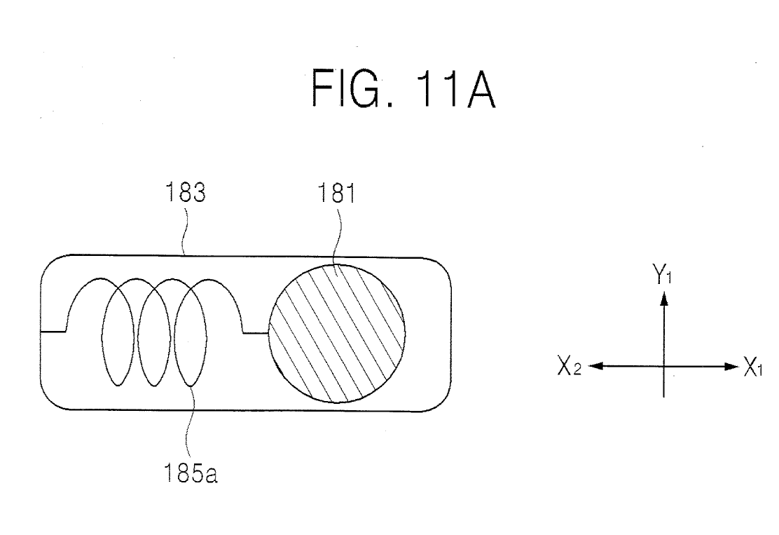

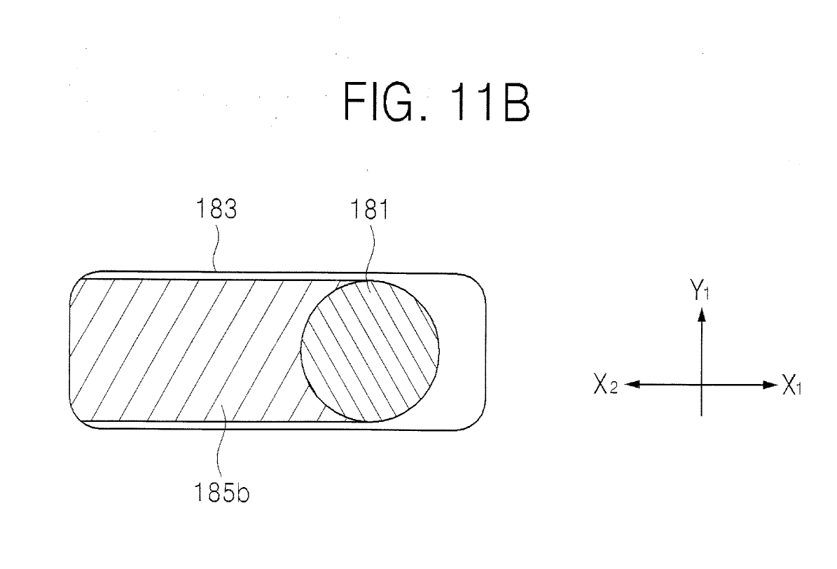

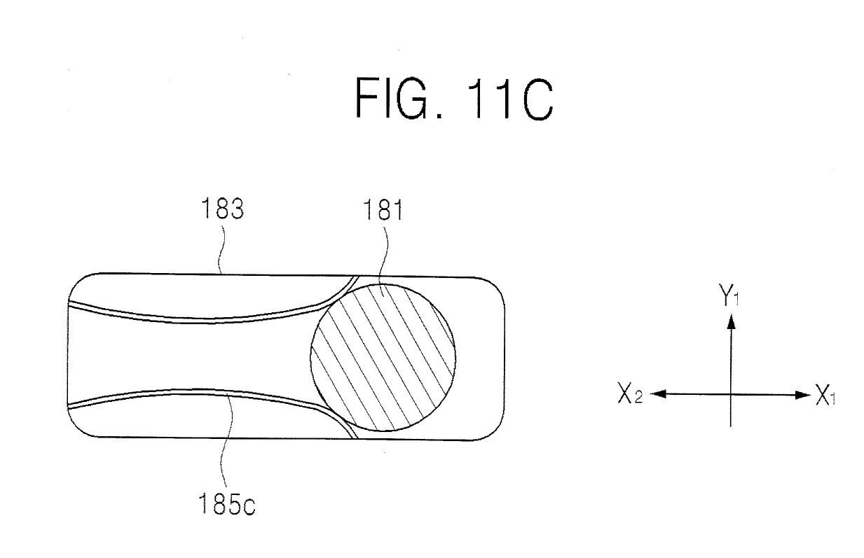

FIGS. 11A-11C illustrate retraction springs 185 according to example embodiments of the present general inventive concept. FIG. 11A illustrates a coil spring 185a connected at one end to a wall of the retracting pin guide 183 and at the other end to the retracting pin 181. FIG. 11B illustrates a compressible material 185b such as a foam, rubber, or other compressible material. As the retracting pin 181 is forced farther in the direction x2 by a shock force, for example, the compressible material 185b may generate a resistive force that increases proportionally as the retracting pin 181 moves farther in the direction x2.

FIG. 11C illustrates a spring 185c that is not directly connected to the retracting pin 181. The spring 185c may include more than one spring 185c, such as two springs 185c as illustrated in FIG. 11C. The spring 185c may be connected to one or more walls of the retraction spring unit 180. As the retracting pin 181 moves in the direction x2, the spring 185c may deform to generate a resistance that increases proportionally the farther the retracting pin 181 moves in the direction x2. The spring 185c may be made of a thin metal strip, or other stiff substance capable of providing a resistive force and returning to an original shape.

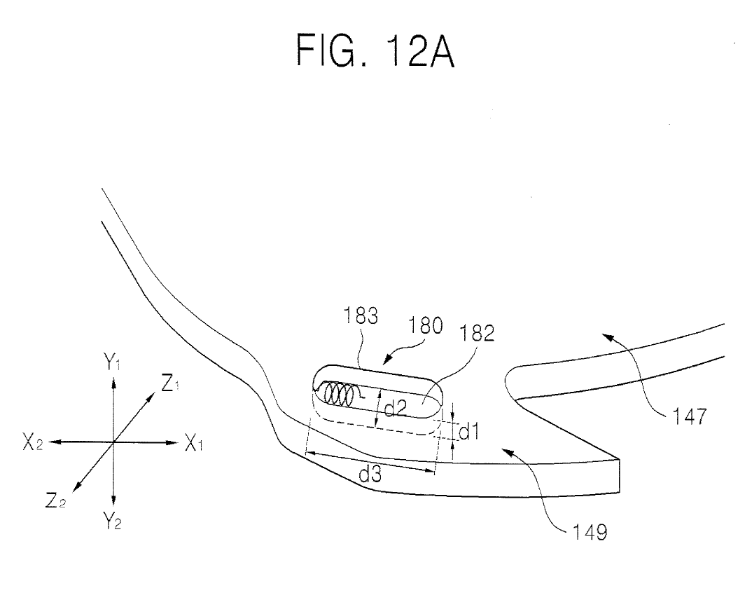

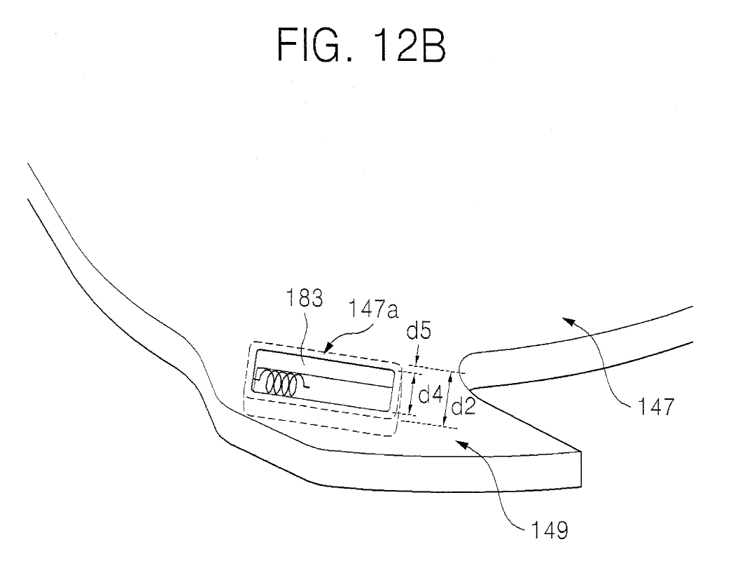

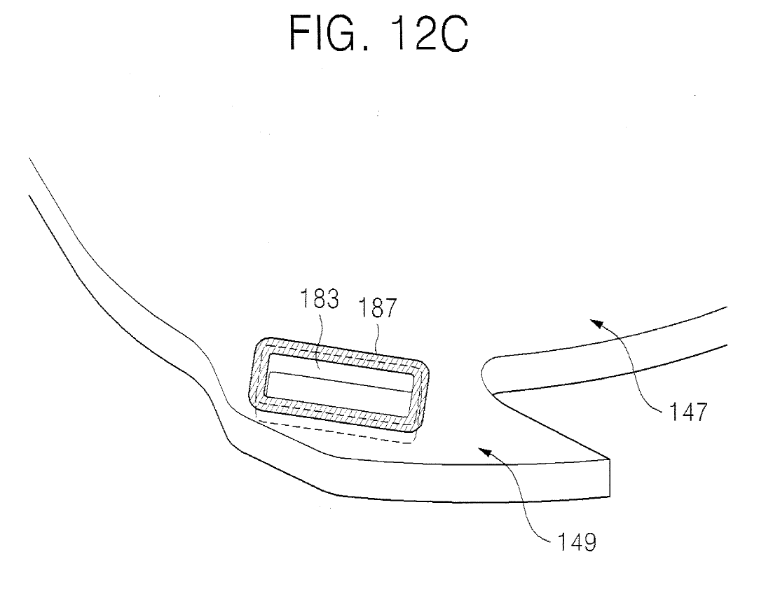

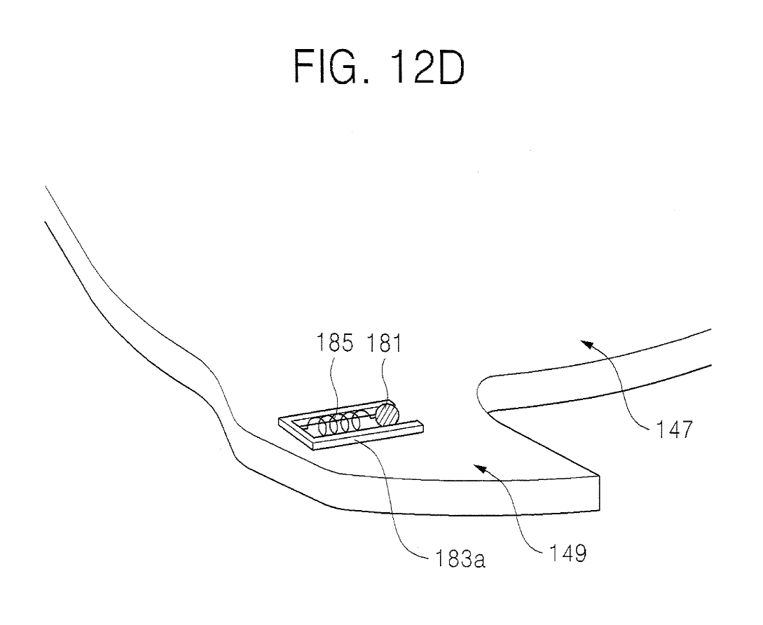

FIGS. 12A-12D illustrate retraction pin units 180 according to embodiments of the present general inventive concept. FIG. 12A illustrates a retraction pin unit 180 including a recess in a surface of the bobbin 147. The retraction pin unit 180 includes a bottom surface 182 and side surfaces or guide rails 183. Alternatively, the retraction pin unit 180 may include a hole that passes through the bobbin 147.

The retraction pin unit 180 may have a depth d1 in a thickness direction y of the bobbin 147. The retraction pin unit 180 may have a length d3 in a direction x that substantially corresponds to a rotation direction of the bobbin 147. For example, as the bobbin 147 rotates counter-clockwise, the hook portion 149 may travel substantially in the direction x1. Thus, when the HDD 100 receives an external shock force and forces the bobbin 147 to move in a counter-clockwise direction, the hook portion 149 may move in the direction x1 and the retraction pin 181 may move in the direction x2 with respect to the movement of the bobbin 147. In other words, even if the retraction pin 181 moves slightly in the direction x1 or stays in the same place, it moves in the direction x2 with respect to the bobbin 147.

The retraction pin unit 180 may also have a width d2 in a horizontal direction z. The width d2 may correspond to a width of the retraction pin 181 and may taper at the ends or remain the same along the length d3 of the retraction pin unit 180.

FIG. 12B illustrates a retraction pin unit 180 having a cover portion or an upper surface opening that is smaller than a width of the inside of the retraction pin unit 180. In FIG. 12B, an upper surface of the bobbin 147 is formed to cover a portion of the retraction pin unit 18. In other words, if the retraction pin holding portion of the retraction pin unit 180 has a width d2, then an opening of the retraction pin unit 180 has a width d4 that is less than d2. The difference d5 between the width d4 and the width d2 may be formed by an upper surface 147a of the bobbin 147, as illustrated in FIG. 12B, by escape prevention units 287, as illustrated in FIG. 9, or by any other mechanism to narrow an opening of the retraction pin unit 180. For example, FIG. 12C illustrates a cover 187 positioned around the edges of the guide rail 183 to narrow the opening of the retraction pin unit 180. The cover 187 may be adhered to the surface of the bobbin 147 with an adhesive, via welding, or any other method to mount the cover 187 to the bobbin 147.

FIG. 12D illustrates a retraction pin unit 180 that is formed on an upper surface of the bobbin 147, rather than in a recess in the bobbin 147. The guide rails 183a may be mounted to the bobbin 147 via adhesives, welds, mechanical screws, or any other method. The retraction spring 185 may be mounted to the guide rails 183a or to the bobbin 147 directly.

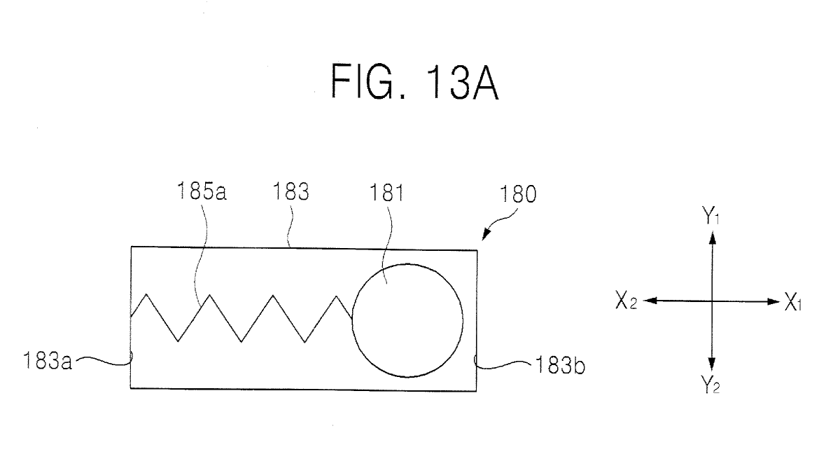

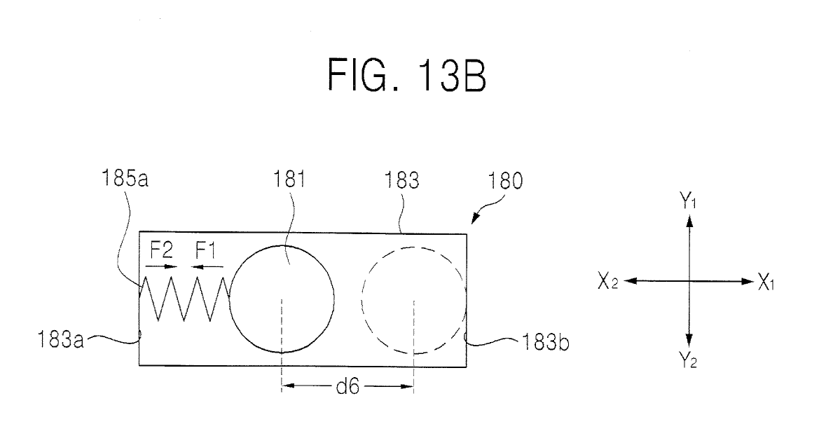

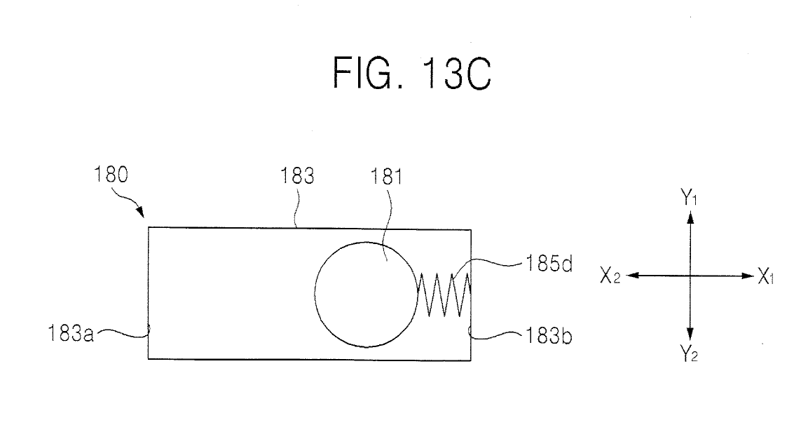

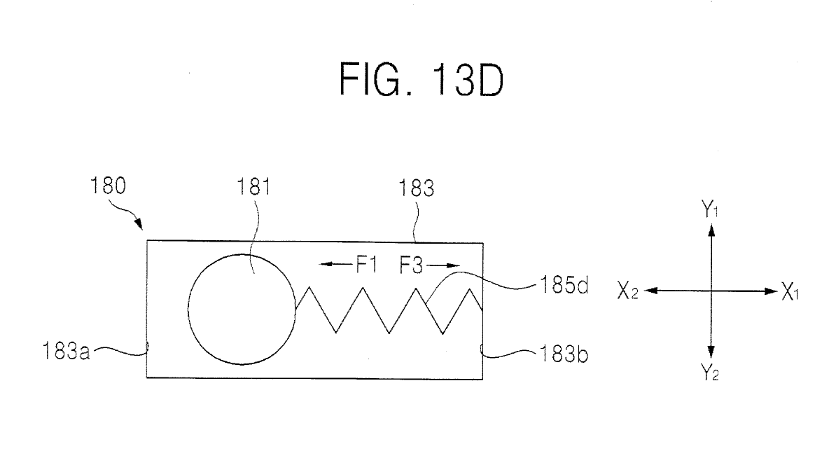

FIGS. 13A-13D illustrate an operation of retraction springs 185 according to the present general inventive concept. FIGS. 13A and 13B illustrate operation of a retraction spring 185a similar to that of FIGS. 1-8. The retraction spring 185a maintains the retracting pin 181 in a rest state at an end of the retraction pin unit 180 corresponding to the direction x1. The retraction spring 185a may be connected to a wall 183a of the retraction pin unit 180 that corresponds to a direction x2. As illustrated in FIG. 13B, when a force F1 is exerted against the retraction pin 181, the retraction pin 181 moves in a direction x2 with respect to the retraction spring 185a and the guide rail 183. The retraction spring 185a exerts a force F2 against the retraction pin 181 that may increase as the retraction pin 181 moves farther in the direction x2 with respect to the retraction spring 185a. The distance d6 between the initial rest position of the retracting pin 181 and the moved position of the retracting pin 181 corresponds to an increase in distance in which the retracting pin 181 may interact with the VCM magnet 151 to help maintain the actuator arm 143 in a parked state.

FIGS. 13C and 13D illustrate an example embodiment in which the retraction spring 185d is connected to a wall 183b of the retracting pin unit 180 that corresponds to a direction x1. In such a case, the retraction spring 185d may be biased in a compressed stated to maintain the retracting pin 181 in a rest state at a side of the retracting pin unit 180 corresponding to the direction x1. When a force F1 is exerted against the retracting pin 181, such as due to an external shock, the retracting pin 181 moves in the direction x2, and the retraction spring 185d, which is biased in the compressed state, exerts a force F3 against the retracting pin 181 in a direction x1 opposite the direction x2 until the retracting pin 181 returns to the initial rest state.

As described above, according to the present general inventive concept, although the bobbin may be separated from the VCM magnet due to an external shock, the retracting pin that coupled to the bobbin is capable of moving relative to the bobbin, which increases the range in which the retracting pin and the magnet may interact to maintain the actuator arm in a parked state. Thus, the head-to-disk contact phenomenon may be reduced or prevented.

While the present general inventive concept has been particularly illustrated and described with reference to exemplary embodiments thereof, it will be understood that various changes in form and details may be made therein without departing from the spirit and scope of the following claims.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A hard disk drive comprising:
a head stack assembly including an actuator arm having a read/write head mounted thereon to pivot across a disk around a pivot shaft installed on a base, a pivot shaft holder to rotatably support the pivot shaft and to which the actuator arm is coupled, and a bobbin located at an opposite side of the actuator arm with respect to the pivot shaft holder and having at least one surface on which a voice coil installed;
a voice coil motor including a magnet to generate an electromagnetic force to pivot the actuator arm by interacting with the voice coil when current flows in the voice coil; and
a retracting pin unit including a mobile retracting pin to generate a retracting force to maintain the actuator arm at a predetermined position by interacting with the magnet when the read/write head is parked, and coupled to the bobbin to be capable of relatively moving with respect to the bobbin toward the magnet when the bobbin is separated from the magnet due to an external shock.

2. The hard disk drive of claim 1, wherein the retracting pin unit comprises:
a pin guide rail located at an end portion of the bobbin and coupled to the bobbin to be capable of relatively moving the mobile retracting pin with respect to the bobbin; and
a retraction spring having one end portion contacting the bobbin and another end portion contacting the mobile retracting pin and elastically biasing the mobile retracting pin to an initially set position.

3. The hard disk drive of claim 2, wherein the retraction spring is an elastic spring that elastically biases the mobile retracting pin toward the initially set position.

4. The hard disk drive of claim 3, wherein the elastic spring is arranged close to the magnet in the pin guide rail, and the mobile retracting pin is arranged at the side of the elastic spring in a direction to be separated from the magnet.

5. The hard disk drive of claim 2, wherein the pin guide rail is located in the bobbin along a rotation direction of the bobbin.

6. The hard disk drive of claim 2, wherein the retracting pin unit includes an escape prevention unit to prevent the mobile retracting pin from escaping from the pin guide rail.

7. The hard disk drive of claim 2, wherein the mobile retracting pin is formed of a magnetic material having the same magnetic polarity as that of the magnet so as to generate an attraction force with the magnet.

8. The hard disk drive of claim 1, further comprising:
a ramp coupled to the base and on which the read/write head is parked; and
a latch device coupled to the base and to lock the actuator arm at a predetermined position when the rotation of the disk is stopped.

9. The hard disk drive of claim 7, wherein the latch device comprises:
a hook portion protruding from the bobbin; and
a latch lever coupled to the base to be capable of pivoting and having a catch portion to catch or release the hook portion, and
wherein the retracting pin unit is coupled to an area of the hook portion.

10. The hard disk drive of claim 7, wherein the latch lever further comprises a latch arm in which the catch portion is located at a leading end portion of the latch arm, and the catch portion comprises:
a first hook located on the latch arm to hook the hook portion; and
a second hook located on the latch arm close to the first hook to hook the hook portion.

11. A head stack assembly, comprising:
an actuator arm to pivot around a shaft; and
a bobbin on a side of the shaft opposite the actuator arm, the bobbin including a retracting pin unit including a pin that moves with respect to the bobbin to maintain a magnetic interaction with a magnet.

12. The head stack assembly according to claim 11, wherein the pin is made of a magnetic material.

13. The head stack assembly according to claim 11, wherein the retracting pin unit comprises:
first rail guides to restrict movement of the pin in a first direction; and
a retraction spring connected to the pin to generate a force in a direction opposite a rotation direction of the bobbin.

14. The head stack assembly according to claim 13, wherein the retracting pin unit includes a recess in a surface of the bobbin, the rail guides comprise side walls of the bobbin, and the pin and retraction spring are located within the recess.

15. The head stack assembly according to claim 13, further comprising:
second rail guides to restrict movement of the pin in a second direction perpendicular to the first direction,
wherein, when a rotation direction of the bobbin is a substantially horizontal third direction, the first direction is a horizontal direction perpendicular to the third direction, and the second direction is a vertical direction perpendicular to each of the first and third directions.

16. The head stack assembly according to claim 15, wherein the second rail guides include a cover mounted to the bobbin to cover a portion of the retracting pin unit.

17. The head stack assembly according to claim 13, wherein the first rail guides are mounted on an outer surface of the bobbin.

18. The head stack assembly according to claim 13, wherein the retraction spring is a coil.

19. The head stack assembly according to claim 13, wherein the retraction spring is a compressible porous material.

20. The head stack assembly according to claim 13, wherein the retraction spring comprises:
a thin metal strip mounted to an inside wall of the retracting pin unit.

21. The head stack assembly according to claim 13, wherein the retraction spring has a de-compressed rest state, such that when a first force is applied to the retraction spring by the pin to move the retraction spring into a compressed state, the retraction spring applies a second force to the pin in a direction opposite the first force to move the retraction spring back into a de-compressed state.

22. The head stack assembly according to claim 13, wherein the retraction spring has a compressed rest state, such that when a first force is applied to the retraction spring by the pin to move the retraction spring into a de-compressed state, the retraction spring applies a second force to the pin in a direction opposite the first force to move the retraction spring back into a compressed state.

23. The head stack assembly according to claim 13, wherein the retraction spring is directly connected to an inside wall of the retracting pin unit and to the pin.

24. The head stack assembly according to claim 13, wherein the retraction spring is directly connected only to an inside wall of the retracting pin unit.

25. The head stack assembly according to claim 11, wherein the bobbin includes a hook portion to hook a latch device, and
the retracting pin unit is located on the hook portion of the bobbin.
